(19) United States
(12) Patent Application Publication
(10) Pub. No.: US 2015/0291836 A1
(43) Pub. Date: Oct. 15, 2015

(54) ORGANIC SEALER FOR MICRO OXIDATION COATING

(71) Applicant: I. D.E. TECHNOLOGIES LTD., Kadima (IL)

(72) Inventor: Izhar Halahmi, Hod Hasharon (IL)

(21) Appl. No.: 14/443,352

(22) PCT Filed: Jul. 10, 2013
(86) PCT No.: PCT/IB2013/055676

§ 371 Date: May 15, 2015

Related U.S. Application Data
(60) Provisional application No. 61/669,700, filed on Jul. 10, 2012.

(51) Int. Cl. C09D 165/04; C09D 5/08; H01B 3/30; C25D 11/02

(52) U.S. Cl. CPC C09D 165/04; C25D 11/026; C09D 5/08; H01B 3/307

(57) ABSTRACT

A method of sealing pores of an oxidation layer of a work-piece that includes the porous oxidation layer disposed on a substrate. The method includes impregnating the pores with a polymerizable gas and polymerizing the gas. In some embodiments, the gas is derived from a paracyclophane, typically heated at low pressure.

### CROSS-REFERENCE TO RELATED PATENT APPLICATIONS

This application claims priority from U.S. Provisional Patent Application No. 61/669,700, filed 10 Jul. 2012, entitled “ORGANIC SEALER FOR MICRO ARC OXIDATION COATING”, the entire contents of which is incorporated herein by reference.

### FIELD OF THE INVENTION

The present invention relates to corrosion protection layers, in particular a method of sealing (coating) porous corrosion protection layers.

### BACKGROUND OF THE INVENTION

Plasma electrolytic oxidation (PEO), also known as micro-arc oxidation (MAO) is an electrochemical surface treatment process used to provide a protective layer on a metal surface. The PEO/MAO process provides a wear and corrosion protection layer that can also impart electrical insulation. The oxidation layer can be thick (e.g. 10-500 micrometers) or thin (e.g. approx. 1 micrometer).

The process is somewhat similar to anodizing, but uses higher potentials, which cause discharging whereby the resulting plasma modifies the structure of the oxide layer. During the MAO process, the metal substrate releases gas and forms pores in the oxide coating. The macro and micro pores produced by the gas should be sealed (coated or filled) in order to avoid diffusion of corrosive ions or dirt infiltration.

Typical sealing processes of anodic coatings are not rigorous because of the small size of the pores and their size distribution. Liquids, such as sol-gel and polymeric solutions, typically only penetrate into the relatively large pores and fail to fill the micro pores; and typically only seal the pores located at or near the outer surface of the oxidation layer.

US 2010/040,787 (Dai, et al., 2010-02-18) discloses an oxide layer sealing process. The process comprises providing a metal coated with a micro-arc oxide film; blending a silicone resin and a diluting agent to make a sealing agent; and applying the sealing agent onto the micro-arc oxide film to form a coating on the film's surface. As a result, the sealing agent is adsorbed into the micro pores of the micro-arc coating.

### SUMMARY OF THE INVENTION

The present invention relates to a method of sealing at least some pores in an oxidation layer on the surface of a substrate; and an oxidation layer having at least some pores sealed by that method. For clarity and readability, herein the specification and claims, the oxidation layer and substrate combination may be referred to as a “work-piece” or derivative of that term. The term “pores” herein the specification and claims will denote “at least some pores” or derivations of that phrase.

According to embodiments of a first aspect of the invention, there is provided a method for sealing pores of the oxidation layer of the work-piece, the method including impregnating the pores with a polymerizable gas (typically a gaseous monomer, dimer, oligomer or mixtures thereof); and polymerizing the gas (which may be, if essentially a spontaneous reaction under the given conditions, a step of allowing the gas to polymerize).

In some embodiments, the method includes producing the polymerizable gas by heating and/or lowering the pressure of a precursor of parylene™ in a vaccuum oven. Parylene™ is a trade name for a variety of chemical vapor depositable poly(p-xylylene) polymers commonly used as moisture and dielectric barriers. The commonly used precursor, [2.2] paracyclophane, typically yields 100% monomer above about 550 ° C. in vacuum. Herein the specification and claims, the term “paracyclophane” will be used to include [2.2] paracyclophane as well as other suitable precursers of poly(p-xylylene) polymers and/or intermediaries and/or variations of those polymers or intermediaries from which a suitable pore-sealing polymer is obtainable. In some embodiments, such precursors or polymers include bromine. In some embodiments, the resultant polymer is at least partially cross-linked. In some embodiments, the resultant polymer is alkylated.

In some embodiments, the paracyclophane is heated between 100_{—} and 800° C. In some embodiments, the paracyclophane is heated between 300_{—} and 750° C.

In some embodiments, in order to enhance diffusion of the polymerizable gas into the pores, as well as facilitating the flow of gas to the oxidation layer of the work-piece, the method includes placing the work-piece in a (vacuum) chamber that is adapted for providing at least a partial vacuum.

In some embodiments, the method includes lowering the pressure inside the vacuum chamber, where the workpiece is located, to below about 0.5 Torr; in some embodiments to a range of about 0.001 to 0.5 Torr; in some embodiments to a range of about 0.001 to 0.1 Torr; and in some embodiments to a range of about 0.1 to 0.5 Torr.

In some embodiments, the method includes placing the vacuum oven, where the paracyclophane is disposed, in fluid communication with the vacuum chamber housing the oxidation layer/substrate.

In accordance with embodiments of another aspect of the present invention there is provided an oxidation layer produced by the above method. In some embodiments, such oxidation layer includes pores wherein at least 20% of those pores are sealed; in some embodiments, sealed with any of the family of poly(p-xylylene) polymers singly or in combination, herein in the specification and claims referred to as “poly(p-xylylene) polymers”.

In some embodiments, the oxidation layer surface is at least partially coated with the aforementioned polymers and/or a composite coating.

In some embodiments that surface layer is in the range of approximately 10 nanometers to 100 micrometers in thickness.

The present invention provides a process for sealing pores and micro pores of the aforementioned oxidation layer. Unlike sealing processes wherein liquids are used to impregnate pores, here, a gas is diffusing into pores, followed by polymerization of the gas.

Advantages of the method of sealing pores in an oxidation layer using a gas-phase sealer for sealing pores in an oxidation layer, in particular in contrast to liquid phase sealers, is that a gas phase sealer does not have the relatively high surface tension of liquids so that the gas diffuses into the pores more easily whereas liquid phase sealers are limited by their ability to wet the surface of the oxidized coating. Also, gas molecules migrate independently and have a lower viscosity whereby diffusion into pores as small as a few nanometers is possible and occurs rapidly, for example within minutes or even seconds. Most liquid sealers are multi-component compounds (resin, catalyst, solvent, etc.) and during penetration/diffusion into pores may separate (such as happens in a chromatograph column). In embodiments using a paracyclophane, a further advantage is that no solvents or catalysts are required for initiating the polymerization.

It is important to note that typical MAO formed coatings have pores of different size, from a few micro-meters down to tens of nano-meters. The smaller the pores, the greater the difficulty to seal the pores using a liquid sealer and thus, the greater the advantage in using a gaseous-phase sealer, as disclosed herein.

It is also important to note, that unlike anodic coating, where pores are typically open to atmosphere, when using MAO, a significant portion of the pores are covered by a MAO matrix (i.e. there are internal pores), which are thus not readily sealed by liquid sealer.

The pore sealing process herein disclosed includes use of a gaseous phase sealer that is capable of diffusing into isolated pores, and after polymerization, to provide a relatively permanent and durable sealing of those pores. The gas monomers can penetrate into small pores. In contrast, liquid sealers have physical limitations such as viscosity and surface tension which, among other things, can limit the liquid's penetration into small pores.

### BRIEF DESCRIPTION OF THE DRAWINGS

The invention may be more clearly understood upon reading of the following detailed description of non-limiting exemplary embodiments thereof, with reference to the following drawings, in which

FIG. 1 is a flow diagram depicting an exemplary embodiment of a method of sealing pores of an oxidation layer of a work-piece, in accordance with the present invention; and

FIG. 2 is a flow diagram depicting another exemplary embodiment of the instant method.

The following detailed description of embodiments of the invention may refer to the accompanying drawing referred to above. Limitations featured in the figure are chosen for convenience or clarity of presentation and are not meant to limit the scope of the invention.

### DETAILED DESCRIPTION

Illustrative embodiments of the invention are described below. In the interest of clarity, not all features/components of an actual implementation are necessarily described.

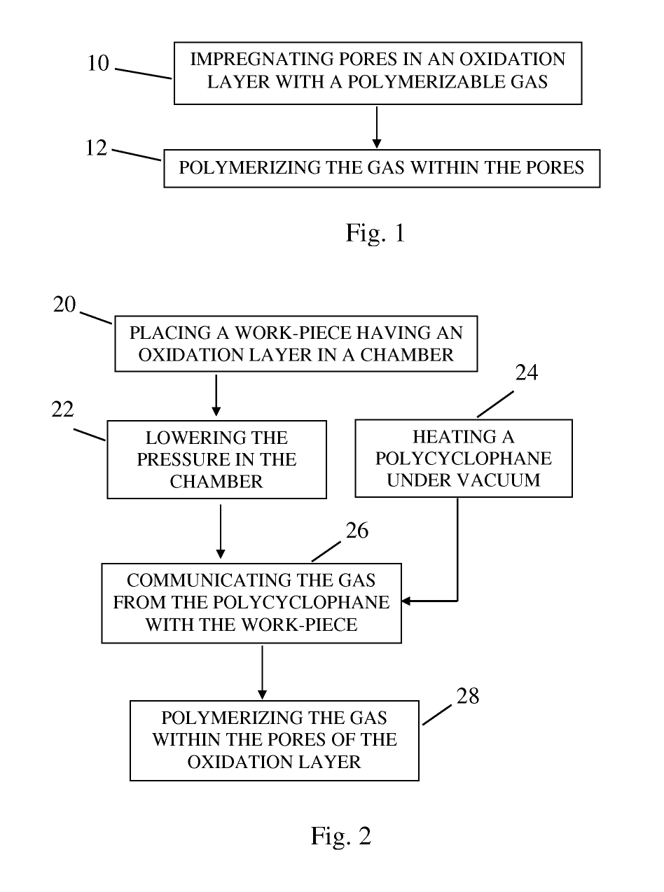

FIG. 1 shows a flow diagram depicting an embodiment of a method of sealing pores of an oxidation layer of a work-piece, the work-piece including the porous oxidation layer disposed on a substrate. The method includes a step 10 of impregnating pores in the oxidation layer with a polymerizable gas; and in a step 12, polymerizing the gas that has diffused within the pores.

FIG. 1 shows a flow diagram depicting another embodiment of the instant method, which includes the following steps, not necessarily in the order noted hereafter. Step 20 includes placing the work-piece in a chamber. Step 22 includes lowering the pressure inside the chamber. The pressure is typically quite low, for example in the range of 0.001 to 0.5 Torr. Step 24 includes heating under vacuum a polycyclophane, either in the aforementioned chamber or a separate chamber (vacuum oven). The “vacuum” is also typically, for example, in the range of 0.001 to 0.5 Torr. Step 26 includes communicating the gas emanating (typically sublimating) from the heated polycyclophane with the work-piece, more specifically with the oxidation layer. In some embodiments, communicating the gas with the work-piece includes depositing (contacting) the gas (monomers, dimers, oligomers or a combination thereof) at the pores. This can be significant step in that gas emanating from the heated polycyclophane has a tendency to spontaneously polymerize and thus ensuring contact at the pores is critical as gas polymerized in locations other than the pores has a low availability to the pores.

However, in some embodiments, the work-piece and paracyclophane are disposed in the same chamber (vacuum oven) and thus step 26 is accomplished automatically. On the other hand, step 26 may entail, for example, opening a valve of a communication tube between the polycyclophane chamber (vacuum oven) and the work-piece chamber.

Step 28 includes polymerizing the gas disposed within the pores of the oxidation layer. In some embodiments, the polymerizing step 28 merely entails contacting the polycylophane gas (monomers, dimers, oligomers or a combination thereof) with the pores, as the gas readily polymerizes on contact without requiring any initiators.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

1. A method of sealing pores of an oxidation layer of a work-piece comprising the porous oxidation layer disposed on a substrate, the method comprising:
impregnating the pores with a polymerizable gas; and
polymerizing the gas.

2. The method of claim 1, wherein the polymerizable gas is a gaseous monomer, dimer, oligomer or mixture thereof.

3. The method of claim 1, wherein the polymerizable gas is derived by heating and/or lowering the pressure of a paracyclophane.

4. The method of claim 3, comprising gasifying the paracyclophane by disposing the paracyclophane in a vacuum oven in fluid communication with the work-piece and heating and lowering the pressure of the vacuum oven.

5. The method of claim 1, wherein impregnating the pores comprises causing the depositing of at least some of the gas at the pores.

6. The method of claim 1, wherein lowering the pressure inside the vacuum oven comprises lowering the pressure to a range of 0.001 to 0.5 Torr.

7. The method of claim 1, wherein heating the paracyclophane inside the vacuum oven comprises heating the paracyclophane to a range of about 100 to 800 degrees Celsius.

8. The method of claim 1, wherein heating the paracyclophane inside the oven comprises heating the paracyclophane to a range of about 300 to 750 degrees Celsius.

9. The method of claim 1, comprising placing the work-piece in a chamber and lowering the pressure inside the chamber to below about 0.5 Torr.

10. The method of claim 1, comprising allowing the gaseous paracyclophane to diffuse into at least 20% of the pores.

11. The method of claim 1, further comprising polymerizing the paracyclophane on the external surface of the oxidation layer.

12. The method of claim 1, further comprising coating the outer surface of the porous layer.

13. An oxidation layer produced by the method defined in claim 1.

14. The layer of claim 13, wherein the oxidation layer includes pores wherein at least 20% of those pores are coated.

15. The layer of claim 13, wherein the pores are coated with a poly(p-xylylene) polymer.

16. The layer of claim 13, wherein the surface of the oxidation layer is coated with a poly(p-xylylene) polymer.

17. The layer of claim 16, wherein the poly(p-xylylene) polymer coating thickness is in the range of about 10 nanometers to 100 micrometers.
